(19) United States
(12) Patent Application Publication
(10) Pub. No.: US 2018/0265228 A1
(43) Pub. Date: Sep. 20, 2018

(54) DUNNAGE AND PACKAGING OPTIMIZATION

(71) Applicants: Lukas Hagestedt, Esslingen am Neckar (DE); Theodore J. Perras, Lawrenceville, GA (US); Jean-Marc Slovencik, Rosenfeld (DE); Hanko Kiessner, Salt Lake City, UT (US); Brandon Brooks, North Salt Lake, UT (US); Paul Hao, Sandy, UT (US)

(72) Inventors: Lukas Hagestedt, Esslingen am Neckar (DE); Theodore J. Perras, Lawrenceville, GA (US); Jean-Marc Slovencik, Rosenfeld (DE); Hanko Kiessner, Salt Lake City, UT (US); Brandon Brooks, North Salt Lake, UT (US); Paul Hao, Sandy, UT (US)

(21) Appl. No.: 15/922,609

(22) Filed: Mar. 15, 2018

Related U.S. Application Data
(60) Provisional application No. 62/472,139, filed on Mar. 16, 2017.

(51) Int. Cl. B65B 5/02; G06F 17/50

(52) U.S. Cl. CPC B65B 5/024; G06F 17/5086; G06Q 50/28; G05B 2219/45048; B65B 2210/04; G06F 2217/38

(57) ABSTRACT

Systems are provided for automatically optimizing packaging and dunnage for a group of objects. The systems calculate dimensions for a custom-made packaging template. The dimensions for the custom-made packaging template are adjusted to allow for a specific amount of dunnage. The systems generate a packaging command that causes a packaging-production machine to generate custom-made packaging templates based upon the calculated dimensions for the custom-made packaging template. The systems also generate a dunnage command that causes a dunnage-production machine to generate the specific amount of dunnage.

### CROSS-REFERENCE TO RELATED APPLICATIONS

This application claims priority to and the benefit of U.S. Provisional Application No. 62/472,139, filed on Mar. 16, 2017, entitled “DUNNAGE AND PACKAGING OPTIMIZATION,” which is incorporated by reference herein in its entirety.

### BACKGROUND

Shipping and packaging industries frequently use paperboard and other fanfold material processing equipment that converts fanfold materials into box templates. One advantage of such equipment is that a shipper may prepare boxes of required sizes as needed in lieu of keeping a stock of standard, pre-made boxes of various sizes. Consequently, the shipper can eliminate the need to forecast its requirements for particular box sizes as well as to store pre-made boxes of standard sizes. Instead, the shipper may store one or more bales of fanfold material, which can be used to generate a variety of box sizes based on the specific box size requirements at the time of each shipment. This allows the shipper to reduce storage space normally required for periodically used shipping supplies as well as reduce the waste and costs associated with the inherently inaccurate process of forecasting box size requirements, as the items shipped and their respective dimensions vary from time to time.

In addition to reducing the inefficiencies associated with storing pre-made boxes of numerous sizes, creating custom sized boxes also reduces packaging and shipping costs. In the fulfillment industry it is estimated that shipped items are typically packaged in boxes that are about 40% larger than the shipped items. Boxes that are too large for a particular item are more expensive than a box that is custom sized for the item due to the cost of the excess material used to make the larger box. When an item is packaged in an oversized box, filling material (e.g., Styrofoam, foam peanuts, paper, air pillows, etc.) is often placed in the box to prevent the item from moving inside the box and to prevent the box from caving in when pressure is applied (e.g., when boxes are taped closed or stacked). These filling materials further increase the cost associated with packing an item in an oversized box.

Custom-sized boxes also reduce the shipping costs associated with shipping items compared to shipping the items in oversized boxes. A shipping vehicle filled with boxes that are 40% larger than the packaged items is much less cost efficient to operate than a shipping vehicle filled with boxes that are custom sized to fit the packaged items. In other words, a shipping vehicle filled with custom sized packages can carry a significantly larger number of packages, which can reduce the number of shipping vehicles required to ship that same number of items. Accordingly, in addition or as an alternative to calculating shipping prices based on the weight of a package, shipping prices are often affected by the size of the shipped package. Thus, reducing the size of an item's package can reduce the price of shipping the item.

Preparing custom-sized packaging provides several benefits to the art. However, additional technical challenges remain relating to the efficient and safe packaging and different types of goods. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein include a system for automatically optimizing packaging and dunnage for a group of objects. In at least one embodiment, the system comprises a dimensional input device configured to gather dimension information describing physical dimensions of one or more objects. The system can also comprise one or more packaging-production machines that are configured to generate custom-made packaging templates based upon the dimension information gathered by the dimensional input device. Additionally, the system can comprise one or more dunnage-production machines that are configured to generate a measured amount of dunnage for packaging based upon the dimension information gathered by the dimensional input device. Further, the system can comprise one or more computer processors configured to calculate dimensions for a custom-made packaging template and dimensions for the dunnage such that a ratio between a volume of the dunnage and a volume associated with the custom-made packaging template conforms with a predetermined threshold.

In at least one additional or alternative embodiment, a method for automatically optimizing packaging and dunnage for a group of objects comprises receiving, from one or more dimensional scanning sensors, dimension information describing physical dimensions of the group of objects. Additionally, the method can comprise calculating, with one or more computer processors, dimensions for a custom-made packaging template. A volume associated with the custom-made packaging template may be greater than a volume described by the dimension information. The dimensions for the custom-made packaging template may be adjusted to allow for a specific amount of dunnage. Additionally, the method may comprise generating a packaging command that causes a packaging-production machine to generate custom-made packaging templates based upon the calculated dimensions for the custom-made packaging template. The method may further comprise generating a dunnage command that causes a dunnage-production machine to generate the specific amount of dunnage.

Further, in at least one additional or alternative embodiment, a computer system is disclosed for automatically optimizing packaging and dunnage for a group of objects. The system may comprise one or more processors and one or more computer-readable media having stored thereon executable instructions that when executed by the one or more processors configure the computer system to perform various acts. For example, the system can be configured to calculate, with one or more computer processors, dimensions for a custom-made packaging template. A volume associated with the custom-made packaging template may be greater than a volume associated with one or more objects that are to be packaged. The dimensions for the custom-made packaging template can be adjusted to allow for a specific amount of dunnage. The specific amount of dunnage may be determined based upon the type of objects within the one or more objects. The system can also be configured to generate a packaging command that causes a packaging-production machine to generate custom-made packaging templates based upon the calculated dimensions for the custom-made packaging template. Further, the system can be configured to generate a dunnage command that causes a dunnage-production machine to generate the specific amount of dunnage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a schematic diagram of an embodiment of a packaging system.

FIG. 2 illustrates a schematic diagram of an embodiment of a packaging system software application.

FIG. 3A illustrates an embodiment of an object to be packaged.

FIG. 3B illustrates a cross-sectional view of the object of FIG. 3A in a package.

FIG. 3C illustrates a cross-sectional view of the object of FIG. 3A in another package.

FIG. 3D illustrates an embodiment of the object of FIG. 3A in another package.

FIG. 3E illustrates an embodiment of the object of FIG. 3A and an additional different object in another package.

FIG. 4 illustrates a flow chart of an exemplary process for packaging items.

FIG. 5 illustrates a flow chart of another exemplary process for packaging items.

### DETAILED DESCRIPTION

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Disclosed embodiments include technological solutions for customizing both packaging configuration and dunnage configuration. Using various disclosed dimension gathering techniques, the dimensions of products to be packaged can be identified. Using the identified dimensions, a custom package (also referred to herein as a “packaging template”) can be generated that is custom-fit to the product. Additionally, using the identified dimensions, a custom dunnage can also be determined.

The specific dimensions of the resulting package and dunnage can be optimized based upon shipping costs, production costs, and specific attributes related to the items being shipped. For example, a fragile product, such as a crystal vase, may require additional dunnage and/or specific types of dunnage in order to protect the crystal vase during transit. As such, a custom package can be generated that can accommodate the necessary dunnage. Similarly, the dunnage can be specially created and/or measured. As such, the resulting dunnage and package are both specially generated simultaneously to meet the needs of the specific object to be shipped.

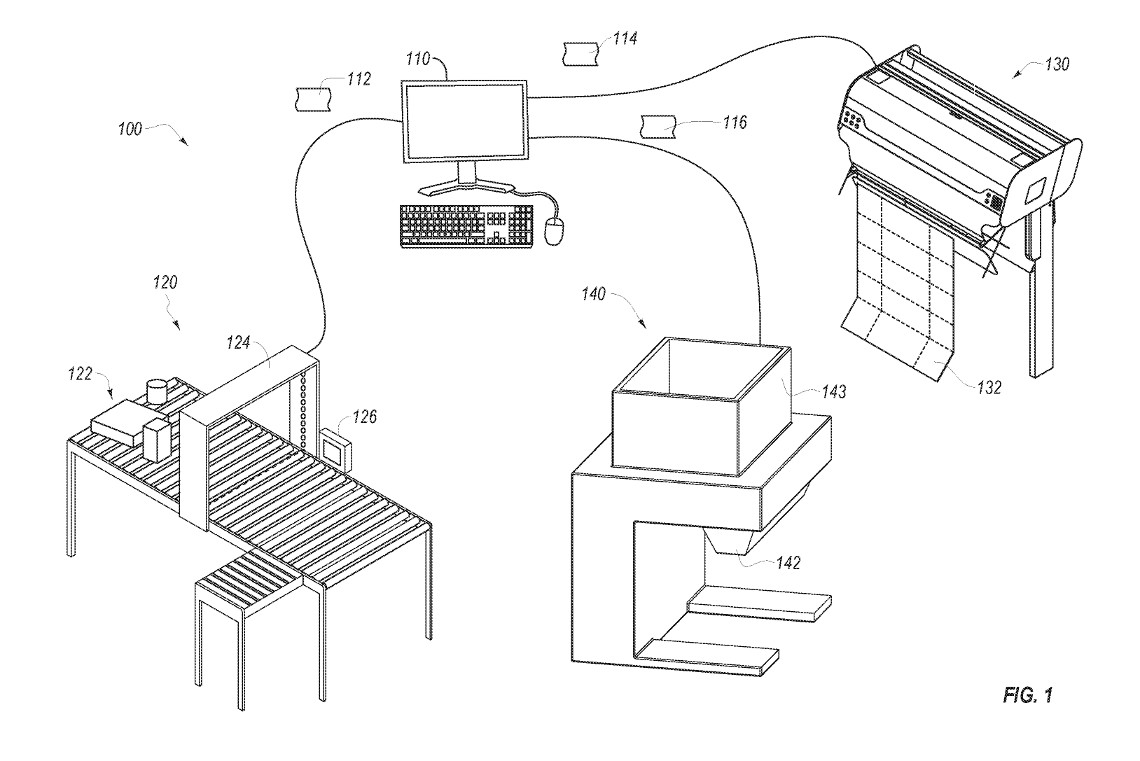

Turning now to the figures, FIG. 1 illustrates a schematic diagram of an embodiment of a packaging system 100. The depicted packaging system 100 comprises various exemplary components, including an embodiment of a packaging system control unit 110, an embodiment of a product intake system 120, an embodiment of a packaging-production machine 130, and an embodiment of a dunnage-production machine 140. The various components and modules of packaging systems 100 described herein are provided only for the sake of clarity and example. One of skill in the art will understand that various alternative or additional modules or components can be used equivalently to the same effect. For example, multiple packaging system control units 110, product intake systems 120, packaging-production machines 130, and/or dunnage-production machines 140 can be used within the scope of the present disclosure.

In at least one embodiment, a picking system (not shown) provides a group of one or more target products 122 (also referred to herein as “objects”) to the product intake system 120. The depicted product intake system 120 comprises a conveyor belt configured to transport the target products 122 through at least a portion of the packaging system 100. Additionally, the product intake system 120 comprises dimensional input devices 124, in the form of one or more scanning sensors. In at least one embodiment, the one or more scanning sensors comprise a light curtain. The light curtain uses various light emitters and light detectors to measure both the height and width of the target products 122.

The depicted light curtain is provided only for the sake of example. In various alternative or additional embodiments, the product intake system comprises multiple dimensional input devices 124, such as light curtains for measuring different cross-sections of the group of one or more target products 122. Further, in additional or alternative embodiments, the product intake system 120 comprises alternative one or more dimensional input devices 124 for determining the dimensions of the target products 122. For example, the one or more dimensional input devices 124 may comprise a URL scanner 126 that scans a URL associated with each of the target products within the group of one or more target products 122. The URL scanner 126 may be in communication with a computer database (not shown) that stores the dimensional information for each product based upon its URL. The product intake system 120 determines the overall dimensions of all the groups of one or more target products 122 based upon the stored dimensions of each individual product. Additionally or alternatively, the one or more dimensional input devices 124 can comprise a LIDAR sensor, a computer vision system, a laser distance measuring sensor, or any other system capable of measuring dimensions. Accordingly, various different apparatus and systems can be used to determine the dimensions of the group of one or more target products 122.

In at least one embodiment, the product intake system 120 comprises multiple different scanners. For example, the product intake system 120 is depicted as comprising one or more dimensional input devices 124, such as a light curtain and one or more URL scanners 126. When the group of one or more target products 122 are scanned, the one or more dimensional input devices 124 generate dimension information about the products and one or more URL scanners 126 generate group information about the products. The dimension information provides dimensional information to the packaging system control unit 110, while the group information provides order information associated with the group of one or more target products 122. In at least one embodiment, a single sensor gathers both the dimension information and the group information.

For instance, one or more of the products may comprise a URL that is associated with the order number, products, address, special order instructions, and/or various other similar information. The group information is used to generate packaging labels for the boxes that are used to package the products. Additionally, the order information can be used to specify particular packaging features, such as the required strength of the final box or the fragility of the products.

Further, in at least one embodiment, the product intake system 120 comprises a scale (not shown). The scale measures the weight of the group of one or more products 122 and sends the information to the packaging system control unit 110. The packaging system control unit 110 uses the weight to determine a proper strength of a box for boxing the group of one or more products. For example, thicker corrugate may be desirable when packaging heavy items, while thinner corrugate may be more cost-effective when boxing less heavy items.

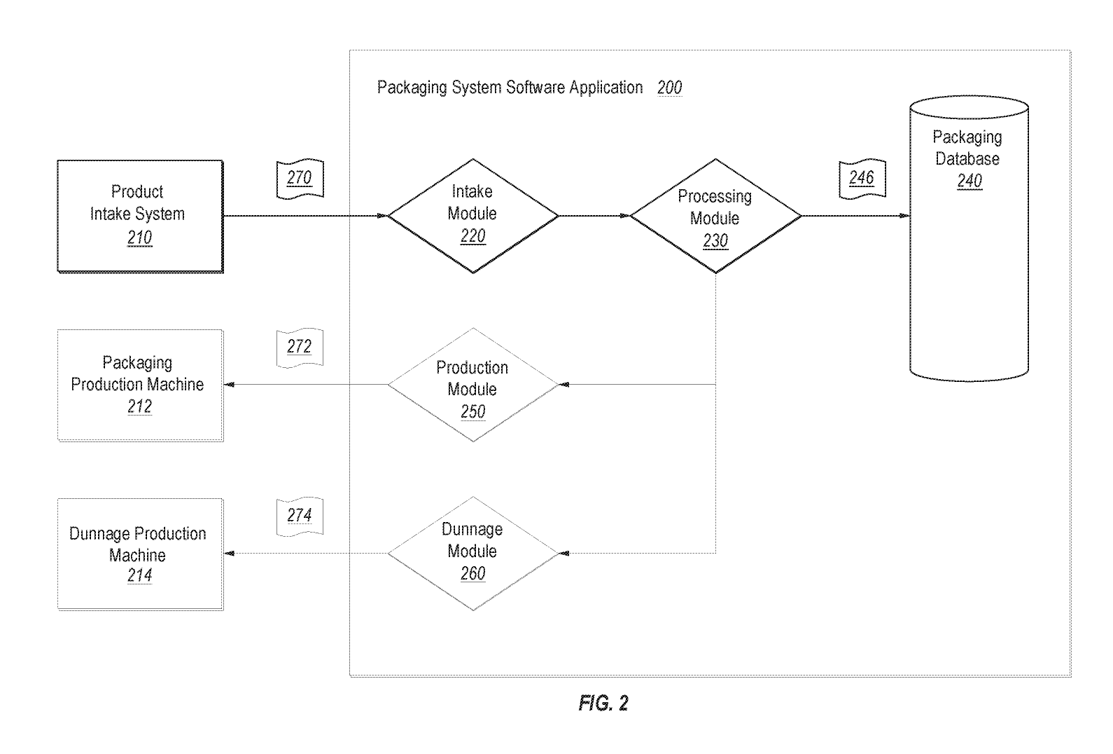

Once the product intake system 120 determines information relating to the physical dimensions of the group of one or more target products 122, the product intake system 120 communicates the information to the packaging system control unit 110. The packaging system control unit 110 may comprise a server, a desktop computer, an embedded system, a microcontroller, a cloud server, or any other computing device capable of communicating and processing information. The packaging system control unit 110 comprises a packaging database (shown in FIG. 2) that contains various information relating to the packaging production system and to the one or more target products 122. For example, the packaging database includes information about available corrugate types, available packaging-production machines 130, available dunnage types, available dunnage-production machines 140, types of products that are to be packaged (e.g., the one or more target products 122), physical characteristics of the products to be packaged, special packaging needs associated with specific products, and other similar information.

In at least one embodiment, the packaging system control unit 110 sends commands to the packaging production machine 130 that cause the machine to generate a custom-made packaging template. The custom-made packaging template may be produced to specially fit the one or more target products 122. Additionally, in at least one embodiment, the packaging system control unit 110 selects the particular packaging production machine 130 and corrugate that will be used to create the packaging template. As such, the packaging system control unit 110 exercises significant control over the dimensions and materials that are used in the construction of a custom-made packaging template.

The packaging production machine 130 comprises any machine capable of producing custom packages or package templates. The packaging production machine 130 is also associated with at least one type of bulk corrugate. For example, a packaging machine may be associated with both a relatively thinner and a relatively thicker corrugate. Additionally, different corrugates may have different strength characteristics, different production costs, different shipping costs, and various other different characteristics.

The packaging system control unit 110 is also in communication with a dunnage production machine 140. The dunnage production machine 140 comprises any machine that is capable of automatically creating, measuring, and/or forming dunnage. For example, the depicted dunnage production machine 140 is configured to dispense from a hopper 143 a measured amount of foam peanuts. The foam peanuts are dispensed from a nozzle 142 into a target package. In additional or alternative embodiments, the dunnage production machine 140 is configured to create, measure, and/or form wood, matting, bubble wrap, air pillows, foam, cardboard, paper, plastic, mold formed cushioning, or any other type of material capable of functioning as dunnage.

FIG. 2 illustrates a schematic diagram of an embodiment of a packaging system software application 200. The software application is depicted with various modules and components that represent different portions of the packaging system software application 200. For example, the depicted embodiment of the packaging system software application 200 includes an intake module 220, a production module 250, a dunnage module 260, a processing module 230, and a packaging database 240. The depicted modules are provided only for the sake of explanation and clarity. In additional or alternative embodiments, the modules may be otherwise combined, divided, or described.

In at least one embodiment, the packaging system software application 200 is executed at least in part by the packaging system control unit 110. In additional or alternative embodiments, the packaging system software application 200 is executed on a distributed system that leverages processing capabilities of the product intake system 210, the packaging production machine 212, and the dunnage production machine 214. Additionally, the packaging system software application 200 may also be executed, at least in part, within a cloud system that leverages processing capabilities of remote servers.

In at least one embodiment, the packaging system software application 200 receives dimension information 270 from the product intake system 210 (shown as 120 in FIG. 1). Specifically, the packaging system software application 200 receives input from a dimensional input device 124 that is configured to gather dimension information 270 describing physical dimensions of one or more objects 122. The dimensional input device 124 may comprise one or more dimensional scanning sensors, such as a light curtain, that scans the one or more objects and identifies physical dimensions of the one or more objects 122. The dimensional information 270 may describe the dimensions of the one or more objects as a group and/or the one or more objects individually.

The packaging system software application 200 is also in communication with one or more packaging-production machines 212 (shown as 130 in FIG. 1) that are configured to generate custom-made packaging templates based upon the dimension information 270 gathered by the dimensional input device 124. The packaging system software application 200 is also in communication with one or more dunnage-production machines 214 (shown as 140 in FIG. 1) that are configured to generate a measured amount of dunnage for packaging based upon the dimension information gathered by the dimensional input device 124.

In at least one embodiment, the processing module 230 comprises one or more computer processors that are configured to calculate dimensions for a custom-made packaging template and dimensions for the dunnage. In at least one embodiment, the dimensions of the custom-made packaging template and the dimensions of the dunnage are calculated such that a ratio between a volume of the dunnage and a volume associated with the custom-made packaging template conforms with a predetermined threshold.

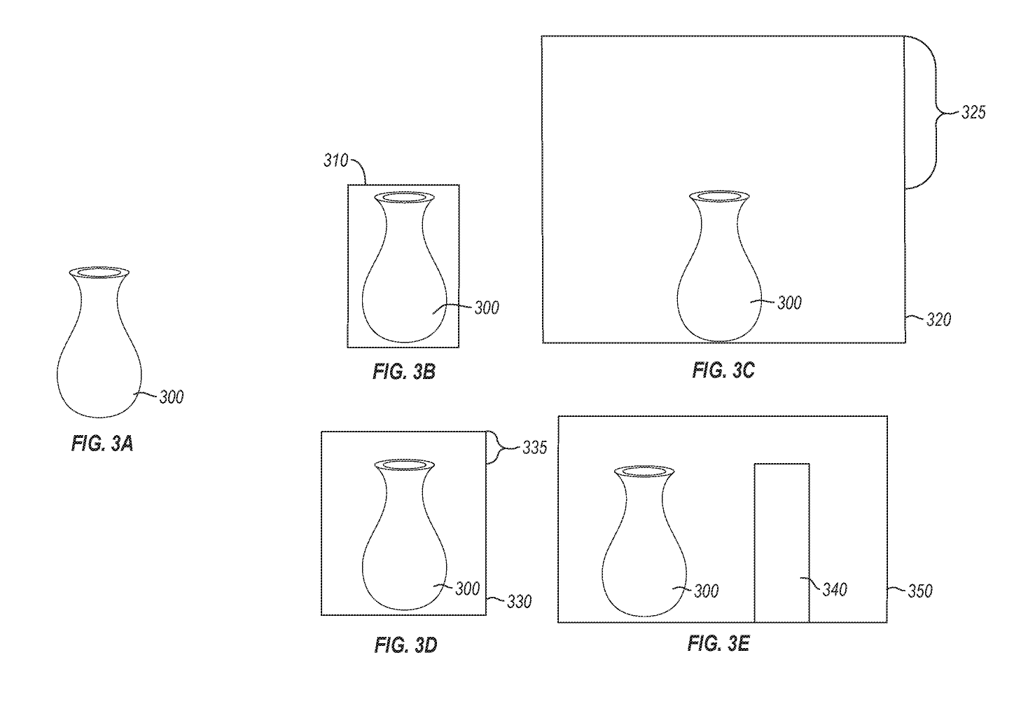

For example, in at least one embodiment, the intake module 220 receives the dimension information 270 from the product intake system 210. The processing module then calculates dimensions for a custom-made packaging template that is sufficiently large to enclose the one or more target products 122. For instance, FIG. 3A depicts a target product in the form of vase 300. FIGS. 3B-3E depict cross-sections of different packages 310, 320, 330, 350 that have been created to enclose the vase 300.

Once the custom-made packaging template has been calculated, the processing module 230 calculates an excess space volume corresponding with the custom-made packaging template with respect to the one or more objects. For example, FIG. 3B shows a package 310 that has almost zero excess space volume with respect to the vase 300. In contrast, FIG. 3C shows a package 320 that has a large amount of excess space volume 325 with respect to the vase 300.

Once the amount of excess space volume has been identified, the processing module 230 calculates the dimensions for the dunnage based upon the excess space volume. For example, the processing module 230 may determine a particular amount of foam peanuts required to fill the excess space volume. Similarly, the processing module 230 may determine the number and size of air pillows required to fill the excess space. Additionally, in at least one embodiment, the processing module 230 calculates dimensions and parameters of a molded foam dunnage structure that form fits the vase 300.

After calculating dimensions for the dunnage, the processing module 230 determines whether the ratio between the volume of the dunnage and the volume associated with the custom-made packaging template conforms with a predetermined threshold. For example, the packaging database 240 comprises packaging information about at least a portion of the one or more target products 122. The packaging information comprises information relating to proper packaging procedures for the target products. For instance, the information may include, the preferred type or types of dunnage, the preferred type of corrugate, the preferred type of package, and/or a protection factor.

The protection factor describes the amount of protection that a particular target product needs to ensure safe packaging. For example, the protection factor may comprise a threshold that describes a ratio between the dunnage and volume associated with the custom-made packaging template. For instance, the predetermined threshold for the vase 300 may indicate that at least twenty-five percent of the volume of the package should comprise dunnage. Further, the packaging information may also indicate that a particular type of dunnage, such as foam peanuts, is the preferred dunnage. In at least one embodiment, the protection factor comprises an indication of the minimum acceptable amount compressed dunnage. For example, foam peanuts have a high compression ratio whereas molded foam dunnage is not as highly compressible. Extremely fragile items may require dunnage that low levels of compressibility in order to ensure that the other items in the packaging do not damage the fragile items.

Additionally, in at least one embodiment, when multiple items are packaged together, the item with the highest threshold ratio of dunnage to volume becomes the ratio for the entire package. As such, if items requiring a low threshold ratio are packaged with items that require a high threshold ratio, the dunnage will be created as if all of the items required the high threshold ratio.

Upon identifying the predetermined threshold, the processing module 230 adjusts the dimensions of the custom-made packaging template and the dimensions of the custom-made dunnage based upon a difference between the ratio and the predetermined threshold. For example, initially the processing module 230 may calculate package 310 for the vase 300. The processing module 230 may then look up the vase 300 in the packaging database 240 and determine that the vase needs a higher ratio of dunnage in order to ensure safe transit. Similarly, the processing module 230 may calculate package 320 for the vase 300. The processing module 230 may then determine that the package 320 comprises too much excess space 325 resulting in wasted packaging materials and dunnage and/or unsafe transport conditions.

In response to the calculations, the processing module 230 eventually arrives at parameters for a custom-made packaging template for transporting vase 300. For example, package 330 has the proper ratio between the excess space volume 335 and the volume associated with the custom-made packaging template (i.e., package 330). In at least one embodiment, the ratio is a predetermined range, such that any configuration that is within the range is acceptable.

Once a proper custom-made packaging template has been determined, the processing module causes the production module 250 to generate a packaging command 272. The production module 250 then communicates the packaging command 272 to the packaging production machine 212, which causes the packaging production machine 212 to generate the calculated custom-made packaging template.

Similarly, once a proper custom-made packaging template has been determined, the processing module causes the dunnage module 260 to generate a dunnage command 274. The dunnage module 260 then communicates the dunnage command 274 to the dunnage production machine 214, which causes the dunnage production machine 214 to generate the calculated dunnage.

FIG. 3E depicts another example of a package 350. The depicted package 350 contains two different target products, the vase 300 and a metal statute 340. In at least one embodiment, the processing module 230 receives dimension information 270 from the product intake system 210 and product information from the URL scanner 126. The processing unit 230 then looks up both target products 300, 340 in the packaging database 240. The packaging database 240 contains information describing the packaging requirements for each respective target product 300, 340.

In at least one embodiment, the vase 300 requires significantly more packaging for safe transit than the metal statute 340 requires. Additionally, in at least one embodiment, the metal statute 340 itself can potentially destroy or damage the vase 300 during transit if they are packaged together. The packaging requirements stored within the packaging database 240 may also comprise information about the fragility and/or damaging aspects of one or more target products.

Using the information from the packaging database 340, the processing module 230 identifies an appropriate ratio between the volume of the dunnage and the volume associated with the custom-made package 350. In at least one embodiment, the ratio is determined based upon the highest ratio requirement associated with a product within the one or more target products. When selecting the particular type of dunnage, the processing module 230 identifies the dunnage type based upon information within the packaging database 240. For example, the processing module 230 may identify that a molded foam dunnage is preferable because it is better at protecting the vase 300 and the metal statute 340, while also keeping them separate from each other. In contrast, foam peanuts may provide cushioning, but may be overly fluid, such that the metal statute 340 and the vase 300 come into physical contact during transit and the metal statute 340 damages the vase 300. In such a case, compressibility of the different dunnage options may determine which dunnage is the appropriate choice.

In some embodiments, the different types of dunnage may be modeled within the packaging system control unit 110. For example, each dunnage may be associated with a fluidity, compressibility, strength, weight, and other various factors. Further, each item may be associated with a protection factor that indicates a different threshold ratio depending on the type of dunnage used. In additional or alternative embodiments, the protection factor may indicate the amount of force that can be placed on an item before damage is likely. The packaging system control unit 110 can then calculate the threshold ratio for each type of dunnage based upon dunnage models. In some calculations, the amount of dunnage required may render a particular dunnage type as being unfit. For instance, it may require a twenty-to-one ratio of foam peanut dunnage to volume in order safely protect the vase 300 from the metal statute 340. In such a case, the packaging system control unit 110 may determine that foam peanuts are not suitable as dunnage because it would waste too much corrugate to make a suitable package size. The packaging system control unit 110 may then decide to either use a different, more suitable type of dunnage or choose to separate the items 300, 340.

Accordingly, disclosed embodiments are capable of intelligently selecting the size and type of dunnage volume and the size and type of packaging templates to meet order-specific needs. In particular, disclosed embodiments automatically minimize shipping and material costs, while at the same time ensuring that sufficient dunnage is provided into a package such that the target products are protected.

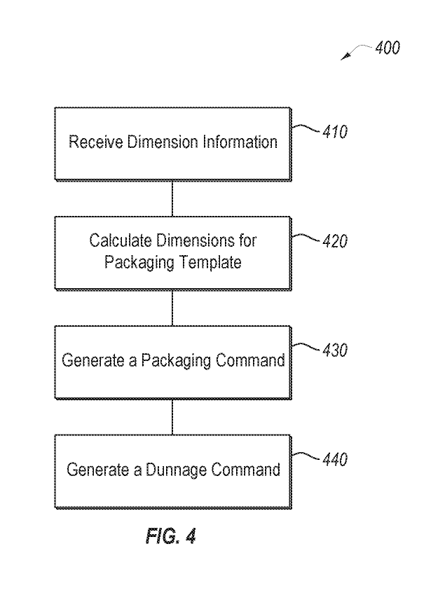

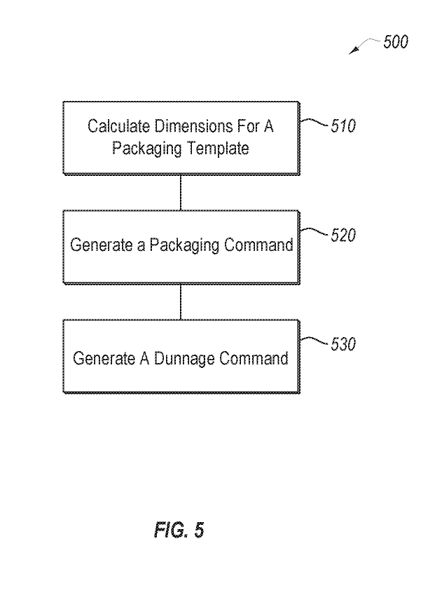

One will appreciate that embodiments disclosed herein can also be described in terms of flowcharts comprising one or more acts for accomplishing a particular result. For example, FIGS. 4 and 5 and the corresponding text describe acts in various methods and systems for automatically optimizing packaging and dunnage for a group of objects. The acts of FIGS. 4 and 5 are described below.

For example, FIG. 4 illustrates that a flow chart of an exemplary method 400 for automatically optimizing packaging and dunnage for a group of objects includes an act 410 of receiving dimension information. Act 410 comprises receiving, from one or more dimensional scanning sensors, dimension information describing physical dimensions of the group of objects. For example, as depicted and described in FIG. 1 and the accompanying description, a product intake scanner 310 comprises one or more dimensional input devices 124 that gather dimensional information about target products.

Additionally, FIG. 4 illustrates that the method 400 includes act 420 of calculating dimensions for a packaging template. Act 420 comprises calculating, with one or more computer processors, dimensions for a custom-made packaging template. A volume associated with the custom-made packaging template is greater than a volume described by the dimension information. Additionally, the dimensions for the custom-made packaging template are adjusted to allow for a specific amount of dunnage. For example, FIG. 2 and the accompanying description describe a processing module 230 that calculates a custom-made packaging template that can be created into a package with interior dimensions that are sized to enclose the one or more target products. Additionally, the processing module 230 adjusts the overall configuration of the packaging template and the dunnage to achieve a particular ratio.

FIG. 4 also illustrates that the method 400 includes an act 430 of generating a packaging command. Act 430 comprises generating a packaging command that causes a packaging-production machine to generate custom-made packaging templates based upon the calculated dimensions for the custom-made packaging template. For example, FIG. 2 illustrates the processing module 230 causing the production module 250 to generate a packaging command 272. The packaging command 272 is sent to a packaging production machine 212 that then generates the calculated custom-made packaging template.

Further, FIG. 4 illustrates that the method 400 includes an act 440 of generating a dunnage command. Act 440 comprises generating a dunnage command that causes a dunnage-production machine to generate the specific amount of dunnage. For example, FIG. 2 illustrates the processing module 230 causing the dunnage module 260 to generate a dunnage command 274. The dunnage command 274 is sent to a dunnage production machine 212 that then generates the calculated specific amount of dunnage.

Turning now to FIG. 5, FIG. 5 illustrates a flow chart of another exemplary process for packaging items. For example, FIG. 5 illustrates that a method 500 for automatically optimizing packaging and dunnage for a group of objects comprises an act 510 of calculating dimensions for a packaging template. Act 510 includes calculating, with one or more computer processors, dimensions for a custom-made packaging template. A volume associated with the custom-made packaging template is greater than a volume associated with one or more objects that are to be packaged. Additionally, the dimensions for the custom-made packaging template are adjusted to allow for a specific amount of dunnage, wherein the specific amount of dunnage is determined based upon a type of objects within the one or more objects. For example, as depicted and described with respect to FIGS. 1 and 2, a product intake system 120 gathers dimensional information about target products. The packaging system control unit 110 the calculates a packaging template that is larger than the target products. The size of the packaging template is adjusted to correctly accommodate the target products and the dunnage.

FIG. 5 also illustrates that the method 500 comprises and act 520 of generating a packaging command. Act 520 includes generating a packaging command that causes a packaging-production machine to generate custom-made packaging templates based upon the calculated dimensions for the custom-made packaging template. For example, FIG. 2 depicts a production module 250 in communication with a packaging production machine 212. The production module 250 generates and communicates a packaging command 272 to the packaging production machine 212.

In addition, FIG. 5 illustrates that the method 500 comprises an act 530 of generating a dunnage command. Act 530 includes generating a dunnage command that causes a dunnage-production machine to generate the specific amount of dunnage. For example, as depicted and described with respect to FIG. 2, the dunnage module 260 generates and communicates a dunnage command 214 to the dunnage production machine 214.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for automatically optimizing packaging and dunnage for a group of objects, the system comprising:
a dimensional input device configured to gather dimension information describing physical dimensions of one or more objects;
one or more packaging-production machines that are configured to generate custom-made packaging templates based upon the dimension information gathered by the dimensional input device;
one or more dunnage-production machines that are configured to generate a measured amount of dunnage for packaging based upon the dimension information gathered by the dimensional input device; and
one or more computer processors configured to calculate dimensions for a custom-made packaging template and dimensions for the dunnage such that a ratio between a volume of the dunnage and a volume associated with the custom-made packaging template conforms with a predetermined threshold.

2. The system as recited in claim 1, wherein the dimensional input device comprises one or more dimensional scanning sensors configured to scan the one or more objects and gather the dimension information describing physical dimensions of the one or more objects.

3. The system as recited in claim 1, wherein the one or more dimensional scanning sensors comprise a light curtain.

4. The system as recited in claim 1, wherein the dimensional input device comprises a universal resource locator (URL) scanner configured to scan at least one URL associated with the one or more objects.

5. The system as recited in claim 1, wherein the URL associated with the one or more objects comprises the dimension information for at least one of the one or more objects.

6. The system as recited in claim 1, wherein the URL associated with the one or more objects comprises information that is associated with a database that indicates dimensions of at least one of the one or more objects.

7. The system as recited in claim 1, wherein calculating dimensions for the custom-made packaging template and for custom-made dunnage comprises:
calculating dimensions for a first custom-made packaging template that is sufficiently large to enclose the one or more objects;
calculating an excess space volume corresponding with the first custom-made packaging template with respect to the one or more objects;
calculating the dimensions for the volume of the dunnage based upon the excess space volume;
determining whether the ratio between the volume of the dunnage and the volume associated with the custom-made packaging template conforms with a predetermined threshold; and
adjusting the dimensions of the custom-made packaging template and the dimensions of the custom-made dunnage based upon a difference between the ratio and the predetermined threshold.

8. The system as recited in claim 7, wherein the predetermined threshold is selected from a set of thresholds that are each associated with different types of objects.

9. The system as recited in claim 1, wherein the volume associated with the custom-made packaging template comprises the internal volume of a finished box that is created from the custom-made packaging template.

10. A method for automatically optimizing packaging and dunnage for a group of objects, the method comprising:
receiving, from one or more dimensional scanning sensors, dimension information describing physical dimensions of the group of objects;
calculating, with one or more computer processors, dimensions for a custom-made packaging template; wherein:
a volume associated with the custom-made packaging template is greater than a volume described by the dimension information, and
the dimensions for the custom-made packaging template are adjusted to allow for a specific amount of dunnage;
generating a packaging command that causes a packaging-production machine to generate custom-made packaging templates based upon the calculated dimensions for the custom-made packaging template; and
generating a dunnage command that causes a dunnage-production machine to generate the specific amount of dunnage.

11. The method as recited in claim 10, wherein the volume associated with the custom-made packaging template comprises the internal volume of a finished box that is created from the custom-made packaging template.

12. The method as recited in claim 10, wherein the specific amount of dunnage is determined based upon the type of objects within the group of objects.

13. The method as recited in claim 10, wherein the specific amount of dunnage is determined based upon a predetermined ratio between a volume of the dunnage and the volume associated with the custom-made packaging template.

14. The method as recited in claim 10, wherein the one or more dimensional scanning sensors comprise a light curtain.

15. The method as recited in claim 10, wherein the dimensional input device comprises a universal resource locator (URL) scanner configured to scan at least one URL associated with the group of objects.

16. The method as recited in claim 10, wherein the URL associated with the group of objects comprises dimensional information for at least one object within the group of objects.

17. The method as recited in claim 10, wherein the URL associated with the group of objects comprises information that is associated with a database that indicates dimensions of at least one object within the group of objects.

18. The method as recited in claim 10, wherein calculating dimensions for the custom-made packaging template comprises:
calculating dimensions for a first custom-made packaging template that is sufficiently large to enclose the one or more objects;
calculating an excess space volume corresponding with the first custom-made packaging template with respect to the one or more objects;
calculating dimensions for the dunnage based upon the excess space volume;
determining whether a ratio between the dunnage and the volume associated with the custom-made packaging template conforms with a predetermined threshold; and
adjusting the dimensions of the custom-made packaging template and the dimensions of the dunnage based upon a difference between the ratio and the predetermined threshold.

19. The method as recited in claim 18, wherein the predetermined threshold is selected from a set of thresholds that are each associated with different types of objects.

20. A computer system for automatically optimizing packaging and dunnage for a group of objects, comprising:
one or more processors; and
one or more computer-readable media having stored thereon executable instructions that when executed by the one or more processors configure the computer system to perform at least the following:
calculate, with one or more computer processors, dimensions for a custom-made packaging template; wherein:
a volume associated with the custom-made packaging template is greater than a volume associated with one or more objects that are to be packaged, and
the dimensions for the custom-made packaging template are adjusted to allow for a specific amount of dunnage, wherein the specific amount of dunnage is determined based upon a type of objects within the one or more objects;
generate a packaging command that causes a packaging-production machine to generate custom-made packaging templates based upon the calculated dimensions for the custom-made packaging template; and
generate a dunnage command that causes a dunnage-production machine to generate the specific amount of dunnage.
